(19) United States
(12) Patent Application Publication
(10) Pub. No.: US 2009/0297375 A1
(43) Pub. Date: Dec. 3, 2009

(54) ELECTROMAGNETIC VALVE, FLUID PUMP HAVING THE VALVE, AND FLUID INJECTOR HAVING THE VALVE

(75) Inventor: Hiroshi INOUE, Anjo-city (JP)

Correspondence Address: NIXON & VANDERHYE, PC, 901 NORTH GLEBE ROAD, 11TH FLOOR, ARLINGTON, VA, 22203, US

(73) Assignee: DENSO CORPORATION, Kariya-city (JP)

(21) Appl. No.: 12/468,295

(22) Filed: May 19, 2009

(30) Foreign Application Priority Data
May 30, 2008 (JP) 2008-142937

(51) Int. Cl. F04B 19/02; F16K 31/02; F15C 3/00

(52) U.S. Cl. 417/460; 251/129.15; 137/561 R

(57) ABSTRACT

An electromagnetic valve includes a valve body having a passage and a valve seat, a valve member engaging/disengaging from the seat to stop/allow a fluid flow through the passage, an urging member urging the valve member, a movable part reciprocating in axial direction with valve member, a connector made of magnetic material and accommodating movable part to allow its reciprocation, a stator made of magnetic material and constituting a magnetic circuit with the movable part and connector to attract the movable part, a coil generating magnetism attracting movable part to stator when energized, a terminal connected to coil for supplying power, and a resin-formed member including an accommodating member embedding the coil and terminal, and a nonmagnetic member made of nonmagnetic material and located radially inward of coil and between the connector and stator for preventing a short circuit. The accommodating member and nonmagnetic member are formed integrally from resin.

### CROSS REFERENCE TO RELATED APPLICATION

This application is based on and incorporates herein by reference Japanese Patent Application No. 2008-142937 filed on May 30, 2008.

### BACKGROUND OF THE INVENTION

1. Field of the Invention

The present invention relates generally to an electromagnetic valve. In particular, the present invention relates to an electromagnetic valve in which a nonmagnetic material that prevents a short circuit of a line of magnetic force is formed from resin.

2. Description of Related Art

Conventionally, an electromagnetic valve that prevents a short circuit of a line of magnetic force by using a nonmagnetic member for a part of a magnetic circuit to ensure attraction force is disclosed (see, for example, JP2001-295720A). However, according to the above configuration, the magnetic circuit does not function without at least three members, i.e., a flange made of a magnetic material, an attraction member made of a magnetic material, and an intermediate member made of a nonmagnetic material, in addition to a movable part. Accordingly, there is a problem that the number of components is large. Moreover, because both ends of the nonmagnetic member need to be fixed liquid-tightly to the magnetic member, they have been sealed and fixed by welding or the like. Consequently, there is a problem that the cost of equipment and operating expenses are great.

An electromagnetic valve which minimizes a short circuit of a line of magnetic force by using a magnetic restrictor to ensure attraction force is disclosed (see, for example, JP60-256550A). In this electromagnetic valve, a magnetic circuit is made up of a single member besides a core. However, a difference occurs in attraction force if the magnetic restrictor part is not precisely formed. Therefore, thickness and length of the magnetic restrictor part need to be precisely formed. Furthermore, there is a problem that it is easy to deform when an injector and the like are attached to an engine or pump sine the magnetic restrictor part has low rigidity.

An electromagnetic valve using a composite magnetic pipe is disclosed (see, for example, JP7-11397A corresponding to U.S. Pat. No. 6,390,443B1). In the above electromagnetic valve, by using the composite magnetic pipe, a magnetic circuit having “magnetism-nonmagnetism-magnetism” is constituted of a single member in addition to a core. Since magnetic properties of a magnetic part of the composite magnetic material are low compared to a magnetic member used for other methods, there is a problem that attraction force is small when their sizes are the same.

### SUMMARY OF THE INVENTION

The present invention addresses the above disadvantages. Thus, it is an objective of the present invention to simplify a process of formation of an electromagnetic valve and to provide an electromagnetic valve including a magnetic circuit having good magnetic properties.

To achieve the objective of the present invention, there is provided an electromagnetic valve including a valve body, a valve member, an urging member, a movable part, a connector, a stator, a coil, a terminal, and a resin-formed member. The valve body has a first fluid passage and a valve seat. The valve member is configured to engage or disengage from the valve seat so as to stop or allow a flow of fluid through the first fluid passage respectively. The urging member is configured to urge the valve member in a direction in which the flow of fluid is stopped or allowed. The movable part is configured to reciprocate in an axial direction thereof together with the valve member. The connector is made of a magnetic material and accommodates the movable part so as to allow reciprocating movement of the movable part. The stator is made of a magnetic material and constitutes a magnetic circuit together with the movable part and the connector so as to attract the movable part. The coil is configured to generate magnetic force upon energization of the coil. The magnetic force attracts the movable part to the stator. The terminal is electrically connected to the coil for supplying a drive current to the coil so as to energize the coil. The resin-formed member includes an accommodating member and a nonmagnetic member. The coil and the terminal are embedded in the accommodating member. The nonmagnetic member is made of a nonmagnetic material and is located radially inward of the coil as well as between the connector and the stator for preventing a magnetic short circuit between the connector and the stator. The accommodating member and the nonmagnetic member are formed integrally from resin.

To achieve the objective of the present invention, there is also provided a fluid pump including an electromagnetic valve and a pump part. The electromagnetic valve includes a valve body, a valve member, an urging member, a movable part, a connector, a stator, a coil, a terminal, and a resin-formed member. The valve body has a first fluid passage and a valve seat. The valve member is configured to engage or disengage from the valve seat so as to stop or allow a flow of fluid through the first fluid passage respectively. The urging member is configured to urge the valve member in a direction in which the flow of fluid is allowed. The movable part is configured to reciprocate in an axial direction thereof together with the valve member. The connector is made of a magnetic material and accommodates the movable part so as to allow reciprocating movement of the movable part. The stator is made of a magnetic material and constitutes a magnetic circuit together with the movable part and the connector so as to attract the movable part. The coil is configured to generate magnetic force upon energization of the coil. The magnetic force attracts the movable part to the stator. The terminal is electrically connected to the coil for supplying a drive current to the coil so as to energize the coil. The resin-formed member has an accommodating member and a nonmagnetic member. The coil and the terminal are embedded in the accommodating member. The nonmagnetic member is made of a nonmagnetic material and is located radially inward of the coil as well as between the connector and the stator for preventing a magnetic short circuit between the connector and the stator. The accommodating member and the nonmagnetic member are formed integrally from resin. The pump part includes a piston and a cylinder body. The piston is configured to pressurize fluid which flows from the electromagnetic valve. The cylinder body accommodates the piston so as to allow sliding reciprocation of the piston.

To achieve the objective of the present invention, there is further provided a fluid injection system including an electromagnetic valve. The electromagnetic valve includes a valve body, a valve member, an urging member, a movable part, a connector, a stator, a coil, a terminal, and a resin-formed member. The valve body has a first fluid passage, a valve seat, and a nozzle hole communicating with the first fluid passage. The valve member is configured to engage or disengage from the valve seat so as to stop or allow a flow of fluid through the first fluid passage respectively. The urging member is configured to urge the valve member in a direction in which the flow of fluid is stopped. The movable part is configured to reciprocate in an axial direction thereof together with the valve member. The connector is made of a magnetic material and accommodates the movable part so as to allow reciprocating movement of the movable part. The stator is made of a magnetic material and constitutes a magnetic circuit together with the movable part and the connector so as to attract the movable part. The coil is configured to generate magnetic force upon energization of the coil. The magnetic force attracts the movable part to the stator. The terminal is electrically connected to the coil for supplying a drive current to the coil so as to energize the coil. The resin-formed member has an accommodating member and a nonmagnetic member. The coil and the terminal are embedded in the accommodating member. The nonmagnetic member is made of a nonmagnetic material and is located radially inward of the coil as well as between the connector and the stator for preventing a magnetic short circuit between the connector and the stator. The accommodating member and the nonmagnetic member are formed integrally from resin. The stator has a cylindrical shape and includes a second fluid passage communicating with the first fluid passage inside the stator.

Moreover, to achieve the objective of the present invention, there is provided a fluid injection system including an electromagnetic valve. The electromagnetic valve includes a valve body, a valve member, an urging member, a movable part, a connector, a stator, a coil, a terminal, a resin-formed member, and a nonmagnetic member. The valve body has a first fluid passage, a valve seat, and a nozzle hole communicating with the first fluid passage. The valve member is configured to engage or disengage from the valve seat so as to stop or allow a flow of fluid through the first fluid passage respectively. The urging member is configured to urge the valve member in a direction in which the flow of fluid is stopped. The movable part is configured to reciprocate in an axial direction thereof together with the valve member. The connector is made of a magnetic material and accommodates the movable part so as to allow reciprocating movement of the movable part. The stator is made of a magnetic material and constitutes a magnetic circuit together with the movable part and the connector so as to attract the movable part. The coil is configured to generate magnetic force upon energization of the coil. The magnetic force attracts the movable part to the stator. The terminal is electrically connected to the coil for supplying a drive current to the coil so as to energize the coil. The resin-formed member has an accommodating member in which the coil and the terminal are embedded. The nonmagnetic member is made of a nonmagnetic material and is located radially inward of the coil as well as between the connector and the stator for preventing a magnetic short circuit between the connector and the stator. The stator has a cylindrical shape and includes a second fluid passage communicating with the first fluid passage inside the stator. The resin-formed member includes a third fluid passage communicating with the second fluid passage.

### BRIEF DESCRIPTION OF THE DRAWINGS

The invention, together with additional objectives, features and advantages thereof, will be best understood from the following description, the appended claims and the accompanying drawings in which:

FIG. 1 is a sectional view illustrating an electromagnetic valve according to a first embodiment of the invention;

FIG. 2 is a sectional view illustrating a high pressure pump using the electromagnetic valve of the first embodiment;

FIG. 3A is a diagram illustrating a method of forming a metal resin complex according to the first embodiment;

FIG. 3B is a diagram illustrating the method of forming the metal resin complex according to the first embodiment;

FIG. 4 is a sectional view illustrating an electromagnetic valve according to a second embodiment of the invention;

FIG. 5 is a sectional view illustrating an injector according to a third embodiment of the invention;

FIG. 6 is a sectional view illustrating an injector according to a fourth embodiment of the invention; and

FIG. 7 is a sectional view illustrating an injector according to a fifth embodiment of the invention.

### DETAILED DESCRIPTION OF THE INVENTION

Embodiments of the present invention are described below with reference to accompanying drawings.

### First Embodiment

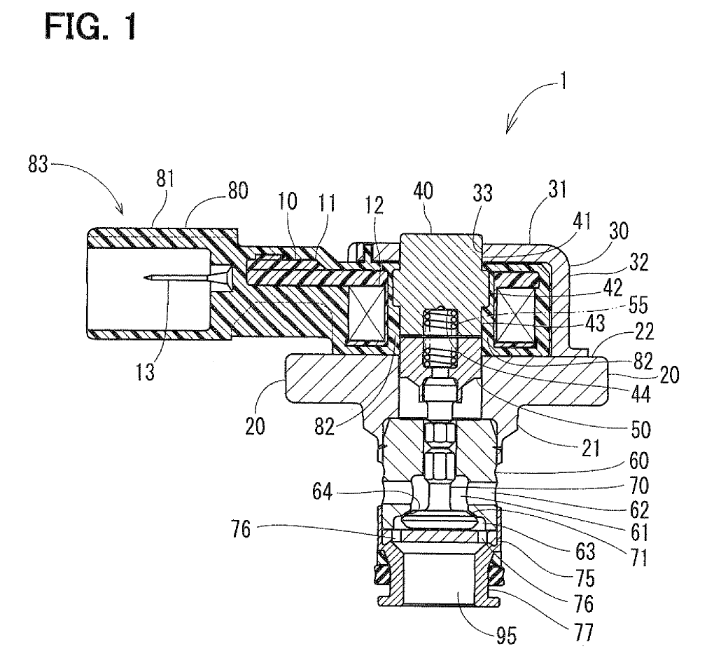

FIG. 1 to FIG. 3B illustrate an electromagnetic valve 1 according to a first embodiment of the invention. The electromagnetic valve 1 is used as a fuel regulating valve of a high pressure supply pump for, for example, a gasoline cylinder direct-injection engine. The electromagnetic valve 1 includes a driving force generating part 10, a connector 20, a housing 30, a stator 40, a movable part 50, a coil spring 55 as an urging member, a valve body 60 as a valve body, a valve member 70, and a resin forming member 80. The driving force generating part 10 includes a bobbin 11, a coil 12, and a terminal 13. The bobbin 11 is disposed radially outward of the stator 40 and the movable part 50. The coil 12 is wound around the bobbin 11. The terminal 13 is electrically connected to the coil 12, and electric power from an external power is supplied to the coil 12 via the terminal 13.

The connector 20 is made of a magnetic material such as magnetic stainless steel, and includes a passage formation part 21 and a flanged portion 22. The passage formation part 21 is cylindrically formed, and accommodates the movable part 50 so as to allow its reciprocative movement. The flanged portion 22 is formed in the shape of a plate having a thickness and projecting radially outward of the passage formation part 21.

The housing 30 is made of a magnetic material such as magnetic stainless steel, and includes a circular plate part 31 and a leg part 32. A fixation hole 33 is formed on the circular plate part 31 in a shape of a cylindrical hole, and the stator 40 is press-fitted into the fixation hole 33. The leg part 32 has an arc-shaped cross section along a part of an outer circumferential edge of the circular plate part 31, and extends from the circular plate part 31 arranged generally parallel to the flanged portion 22 toward the flanged portion 22. An extension-side front end surface of the leg 32 is in contact with the flanged portion 22.

The stator 40 and the movable part 50 are made of a magnetic material such as magnetic stainless steel, and together with the connector 20 and the housing 30, constitute a magnetic circuit upon energization of the coil 12. The stator 40 includes a first minor diameter part 41, a major diameter portion 42, and a second minor diameter part 43 in this order from its one end part side toward the other end part side in the axial direction. The columnar first minor diameter part 41 is fit-fixed in the fixation hole 33 of the housing 30. The second minor diameter part 43 having a cylindrical shape with a bottom portion includes a recess 44 that accommodates one end part of the coil spring 55.

The movable part 50 is disposed to be reciprocated radially inward of the passage formation part 21 of the connector 20. The coil spring 55 is arranged between the stator 40 and the movable parts 50. Urging force of the coil spring 55 is applied in a direction in which the movable part 50 is separated from the stator 40 and a seat part 71 is disengaged from a valve seat 64. The movable part 50 is attracted in a direction of the stator 40 against the urging force of the coil spring 55 by magnetic attraction force generated upon energization of the coil 12.

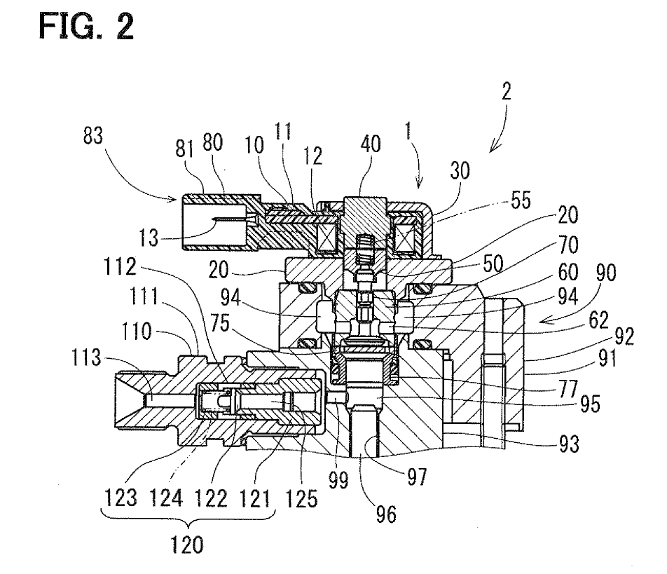

The valve body 60 is formed in a cylindrical shape, and is attached coaxially with the passage formation part 21 of the connector 20. The valve body 60 defines a first communicating hole 62 that communicates between a cylindrical internal passage 61 and a suction passage 94 (see FIG. 2) formed in the outer circumference of the electromagnetic valve 1, and a second communicating hole 63 that communicates with a fuel hole 76 of a stopper plate 75. The first communicating hole 62, the internal passage 61, and the second communicating hole 63 communicate between the suction passage 94 and a pressurizing chamber 95 through the fuel hole 76. The valve seat 64, which the valve member 70 engages or disengages from, is formed between the internal passage 61 and the second communicating holes 63 on the valve body 60.

The valve member 70 is formed integrally with the movable part 50 on the opposite side of the movable part 50 from the stator 40, and is disposed on inner circumferential sides of the passage formation part 21 and the valve body 60 coaxially therewith, so as to reciprocate together with the movable part 50 in the axial direction. The seat part 71 which engages or disengages from the valve seat 64 is formed on the valve member 70. When the seat part 71 of the valve member 70 disengages from the valve seat 64, the internal passage 61 and the second communicating hole 63 communicate therebetween. When the seat member 71 engages the valve seat 64, the communication between the internal passage 61 and the second communicating hole 63 is closed.

The stopper plate 75 is formed in the shape of a generally circular plate, and has the fuel hole 76. The stopper plate 75 is held between the valve body 60 and a sleeve 77, and welded to them. The sleeve 77 is formed in a generally cylindrical shape. The sleeve 77 is inserted in a housing main body 93 of a pump part 90 (see FIG. 2). The first communicating hole 62, the internal passage 61, the second communicating hole 63, and the fuel hole 76 constitute a “first fluid passage”

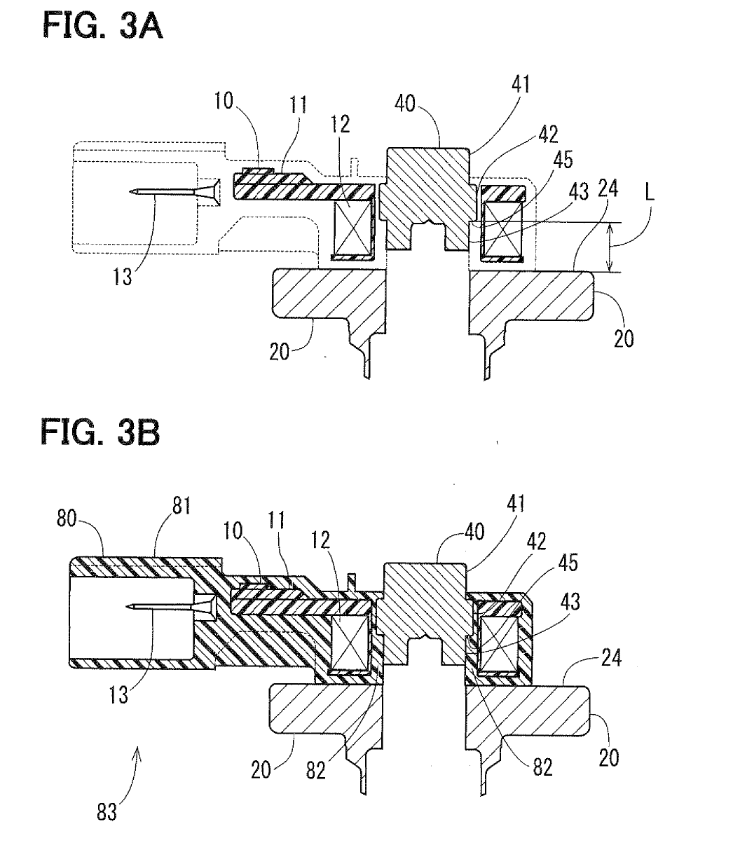

A resin formed member 80 includes an accommodating member 81 and a nonmagnetic member 82, and the accommodating member 81 and the nonmagnetic member 82 are integrally formed from resin. The bobbin 11, the coil 12, and the terminal 13 are embedded in the accommodating member 81. The nonmagnetic portion 82 is located radially inward of the coil 12 as well as between the connector 20 and the stators 40. The nonmagnetic portion 82 prevents a short circuit of magnetic flux between the connector 20 and the stators 40. The driving force generating part 10, the connector 20, the stator 40, and the resin formed member 80 are integrally formed as a metal resin complex 83. A method of forming the metal resin complex 83 is described in greater detail hereinafter with reference to FIG. 3A and FIG. 3B.

An operation of the electromagnetic valve 1 is described below. When the energization of the coil 12 is stopped, magnetic attraction force is not produced between the stator 40 and the movable part 50. Accordingly, the valve member 70 is displaced in the opposite direction from the stator 40 together with the movable part 50 by urging force of the coil spring 55. In other words, when the energization of the coil 12 is stopped, the seat part 71 of the valve member 70 is disengaged from the valve seat 64. Thus, the internal passage 61 and the second communicating hole 63 communicate with each other with the valve member 70 in engagement with the stopper plate 75.

Upon energization of the coil 12, a magnetic circuit is formed in the stator 40, the housing 30, the connector 20 and the movable part 50 by a magnetic field generated in the coil 12. Meanwhile, the nonmagnetic member 82 prevents the short circuit of magnetic flux between the connector 20 and the stators 40. Accordingly, magnetic attraction force is generated between the stator 40 and the movable parts 50. When the magnetic attraction force generated between the stator 40 and the movable parts 50 becomes larger than the urging force of the coil spring 55, the movable part 50 and the valve member 70 are displaced integrally toward the stator 40 side. As a result, the seat part 71 engages the valve seat 64. Therefore, the communication between the internal passage 61 and the second communicating hole 63 is closed. Meanwhile, a clearance is formed between the stator 40 and the movable parts 50, and the stator 40 and the movable part 50 are not in contact with each other.

When the energization of the coil 12 is stopped, the magnetic attraction force between the stator 40 and the movable part 50 no longer exists. Accordingly, the movable part 50 and the valve member 70 are displaced integrally in the opposite direction from the stator 40 by the urging force of the coil spring 55. As a result, the seat part 71 disengages from the valve seat 64 again. Thus, the internal passage 61 and the second communicating hole 63 communicate with each other with the valve member 70 in engagement with the stopper plate 75.

A high pressure pump using the electromagnetic valve 1 is illustrated in FIG. 2. A high pressure pump 2 as a fluid pump includes the electromagnetic valve 1 and the pump part 90 which pressurizes and discharges suctioned fuel. The high pressure pump 2 controls a discharged amount of high pressure fuel through the opening and closing of the electromagnetic valve 1. A pump housing 91 of the pump part 90 is constituted of a housing cover 92 and a housing main body 93. The housing cover 92 defines the suction passage 94 on the outer circumferential side of the valve body 60. Fuel from a fuel tank is supplied to the suction passage 94 by a low pressure pump (not shown). The suction passage 94 communicates with the first communicating hole 62.

The housing main body 93 defines a cylinder 97 as a cylinder body that accommodates a plunger 96 as a piston so as to allow its reciprocation movement. The pressurizing chamber 95 is defined by an inner circumferential surface of the housing main body 93 which defines the cylinder 97, an inner circumferential surface of the sleeve 77, an end face of the plunger 96 on the electromagnetic valve 1 side, and an end face of the stopper plate 75 on the plunger 96 side. The plunger 96 reciprocates in the axial direction by drive of a cam (not shown).

A delivery valve 110 is attached to the housing main body 93. The delivery valve 110 has a casing 111. The housing main body 93 defines a discharge passage 99 which communicates with the pressurizing chamber 95. The casing 111 is formed in a cylindrical shape, and has an accommodating part 112, which accommodates a discharge valve 120 therein, and a fuel passage 113.

The discharge valve 120 is accommodated inside the casing 111, and includes a valve body 121, a valve member 122, a passage formation member 123 and a spring 124. The valve body 121 is formed in a cylindrical shape, and disposed inside the casing 111. The inner circumferential side of the valve body 121 defines a fuel passage 125 which communicates with the discharge passage 99. The valve member 122 engages an end portion of the valve body 121 on the passage formation member 123 side. The passage formation member 123 is arranged on the opposite side of the valve body 121 from the housing main body 93. The valve member 122 is formed in the shape of a circular plate, and reciprocates inside the passage formation member 123 in an axial direction of the passage formation member 123. The spring 124 urges the valve member 122 in a direction of the valve body 121.

When pressure in the fuel passage 125 of the valve body 121, which communicates with the discharge passage 99, increases in accordance with the pressurization of fuel in the pressurizing chamber 95, force that presses the valve member 122 applied by fuel in the fuel passage 125 is increased. When the force applied to the valve member 122 by the fuel in the fuel passage 125 becomes larger than force applied to the valve member 122 by fuel in the fuel passage 113 and the spring 124, the valve member 122 disengages from the valve body 121. As a result, the discharge passage 99 and the fuel passage 113 of the casing 111 communicate with each other, and the pressurized fuel is discharged into the outside of the high pressure pump 2. On the other hand, when the pressure in the fuel passage 113 is higher than the pressure in the discharge passage 99, the valve member 122 engages the valve body 121 so as to stop a flow of fuel from the fuel passage 113 to the discharge passage 99. In other words, the discharge valve 120 functions as a check valve which allows only a flow of fuel from the pressurizing chamber 95 to the outside.

Workings of the high pressure pump 2 employing the electromagnetic valve 1 are explained below. When the plunger 96 is displaced from a top dead center to a bottom dead center by the drive of the cam (not shown), the electromagnetic valve 1 opens, and accordingly a predetermined amount of fuel flows from the suction passage 94 into the pressurizing chamber 95. When the plunger 96 moves up, the fuel in the pressurizing chamber 95 is discharged into the suction passage 94. After a predetermined amount of fuel is discharged into the suction passage 94, the electromagnetic valve is closed. The fuel in the pressurizing chamber 95 is pressurized as a result of the upward movement of the plunger 96. When the pressure of the fuel in the pressurizing chamber 95 increases, fuel pressure of the discharge passage 99 also increases. When the pressure of the fuel in the discharge passage 99 becomes larger than the pressure in the fuel passage 113, the discharge valve 120 is opened, and thereby the fuel is discharged into the outside of the high pressure pump 2 from the pressurizing chamber 95.

The invention is characterized in that the accommodating member 81 and the nonmagnetic portion 82 are formed integrally from resin. First, a method of forming a nonmagnetic member of an electromagnetic valve according to conventional technology is described below. A first press fitting process (1) of press-fitting the nonmagnetic member, which is cylindrically formed from non-magnetic metal, into a connector; a first laser welding process (2) of laser-welding a projection of the connector and the nonmagnetic member together; and a cutting process (3) of performing cutting operations on their inner diameter parts in order to ensure concentricity between the connector and the nonmagnetic member, are carried out. Furthermore, a second press fitting process (4) of press-fitting a stator into the formed complex of the connector and the nonmagnetic member; and a second laser welding process (5) of laser-welding a joining portion with the nonmagnetic member, are carried out. In total, five processes have been needed.

Since moisture may enter into among the stator, the connector and the nonmagnetic member which are formed integrally from metal such as stainless steel, a bobbin formed from resin, and a resin part in which the bobbin and a terminal are embedded, a sealing part needs to be provided for the bobbinto limit this problem, and accordingly cost of the bobbin rises.

Next, the method of forming the nonmagnetic member in the first embodiment is described below. FIG. 3A illustrates a preparatory stage for formation of the resin formed member 80 using a metal mold (not shown). The stator 40 is arranged such that a position of an end portion of the major diameter portion 42 of the stator 40 on the opposite side from the connector 20 generally accords with a position of an end portion of an inner circumference of the bobbin 11 on the opposite side from the connector 20, and the stator 40 is located radially inward of the bobbin 11. The connector 20 is disposed with a distance L between an end portion 24 of the connector 20 on the stator 40 side and an end portion 45 of the major diameter portion 42 on the connector 20 side. The distance L needs to be set such that a clearance is left between the stator 40 and the movable parts 50 when the movable part 50 is attracted in the direction of the stator 40 against the urging force of the coil spring 55 by the magnetic attraction force generated as a result of the energization of the coil 12, and thereby the seat part 71 of the valve member 70 engages the valve seat 64. The distance L may be short to ensure predetermined responsivity, and the connector 20 is arranged by setting the distance L appropriately so as to satisfy such conditions.

As shown in FIG. 3B, the resin formed member 80 is insert-molded using the metal mold (not shown) to integrate the driving force generating part 10, the connector 20, and the stator 40, which are arranged appropriately. A joining portion between the resin and metal is integrally processed liquid-tightly by, for example, an NMT (nano molding technology) method. Consequently, the metal resin complex 83, in which the driving force generating part 10, the connector 20, the stator 40 and the resin formed member 80 are integrally formed, is produced. Meanwhile, a region defined among the bobbin 11, the stator 40 and the connectors 20 is the nonmagnetic member 82, and has a function of preventing the short circuit of magnetic flux between the connector 20 and the stators 40.

The housing 30 is press-fitted and welded on the metal resin complex 83, in which the driving force generating part 10, the connector 20, the stator 40 and the resin formed member 80 are integrally formed by the method shown in FIG. 3A and FIG. 3B. Also, the coil spring 55, the valve body 60, the movable part 50, and the valve member 70 are attached to the metal resin complex 83 by valve assembly welding. Furthermore, the stopper plate 75 and the sleeve 77 are welded onto the valve body 60, and accordingly, the electromagnetic valve 1 is formed.

As has been described in detail thus far, the process of forming a nonmagnetic member is conventionally carried out in the five processes including laser welding. According to the electromagnetic valve 1 in the first embodiment, the process of forming a nonmagnetic member is carried out in a single process by performing the insert molding after positioning the driving force generating part 10, the stator 40, and the connector 20 at their appropriate positions. Because the laser welding between the connector 20 and the stator 40, and the nonmagnetic member 82 becomes unnecessary, a projection conventionally provided for the connector 82 does not need to be used. Furthermore, a joining surface between the driving force generating part 10, the connector 20 and the stator 40, and the resin formed member 80, is integrally formed liquid-tightly as the metal resin complex 83. Therefore, the sealing part conventionally provided for the bobbin 11 becomes unnecessary. Because the forming process is simplified, the number of components is reduced, and the shape of the bobbin 11 or the connector 20 is simplified, the cost is greatly reduced.

The metal resin complex 83 may be formed, for example, by the NMT method. Metal are resin may be joined by any method as long as metal and resin are integrally processed liquid-tightly. Since resin and metal are liquid-tightly joined as a continuous element, a sealing part which is conventionally provided for the bobbin 11, for example, becomes unnecessary, and thereby a single piece of the bobbin 11 is provided at a low cost.

Moreover, the first embodiment is characterized in that the nonmagnetic member 82 is formed integrally with the accommodating member 81 which accommodates the driving force generating part 10. If positions of the driving force generating part 10, the stator 40, and the connector 20 are appropriately determined using a configuration of the first embodiment, the attraction is stabilized without precise formation of thickness and length of the nonmagnetic member 82 as in the conventional technology. In addition, the resin formed member 80 is formed integrally as the metal resin complex 83 with the driving force generating part 10, the stator 40 and the connector 20, so that the joint strength improves and rigidity is high. As a result, their deformations in attaching the engine or pump is prevented. Also, because a material having good magnetic properties is selected for the magnetic member, a magnetic circuit having good magnetic properties is configured.

Because the nonmagnetic member 82 is formed from resin integrally with the accommodating member 81 by insert molding, the number of components is reduced. When the connector 20 and the resin part are liquid-tightly fixed, and the stator 40 and the resin part are liquid-tightly fixed only by insert molding using resin, for instance, the connector 20 and the stator 40 do not need to be welded together. Accordingly, the working process is simplified. If a material having good magnetic properties is selected without respect to weldability for a member which constitutes a magnetic circuit, a magnetic circuit having good magnetic properties is formed.

The metal resin complex 83 may be formed, for example, by the NMT method. Metal are resin may be joined by any method as long as metal and resin are integrally processed. Consequently, joint strength between metal and resin improves, so that rigidity is increased. Therefore, deformation is not easily caused when the electromagnetic valve is attached to an engine or pump.

### Second Embodiment

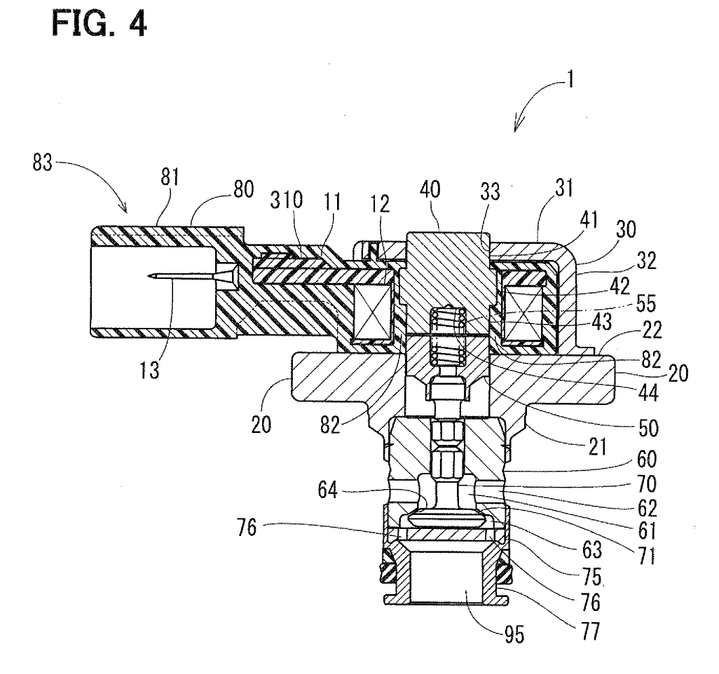

An electromagnetic valve according to a second embodiment of the invention is illustrated in FIG. 4. In the present embodiment, the same numeral as the first embodiment is used for indicating substantially the same component as the first embodiment. In an electromagnetic valve 3 of the second embodiment, a terminal 313 is held by a plate-like terminal holding member 314 made of resin, and a coil 312 is an air-core coil.

A driving force generating part 310 includes the air-core coil 312 without using a bobbin, the terminal 313 and the terminal holding member 314. By forming integrally the driving force generating part 310, a stator 40, a connector 20 and a resin formed member 80 as a metal resin complex 383, the electromagnetic valve 3 has a similar effect to the first embodiment. Furthermore, by eliminating a bobbin, the number of components is reduced.

In the above embodiments, the electromagnetic valve used for a high pressure pump is described. However, the electromagnetic valve by the invention may be applied for various uses. An example in which the electromagnetic valve of the invention is applied to an injector is described as follows.

### Third Embodiment

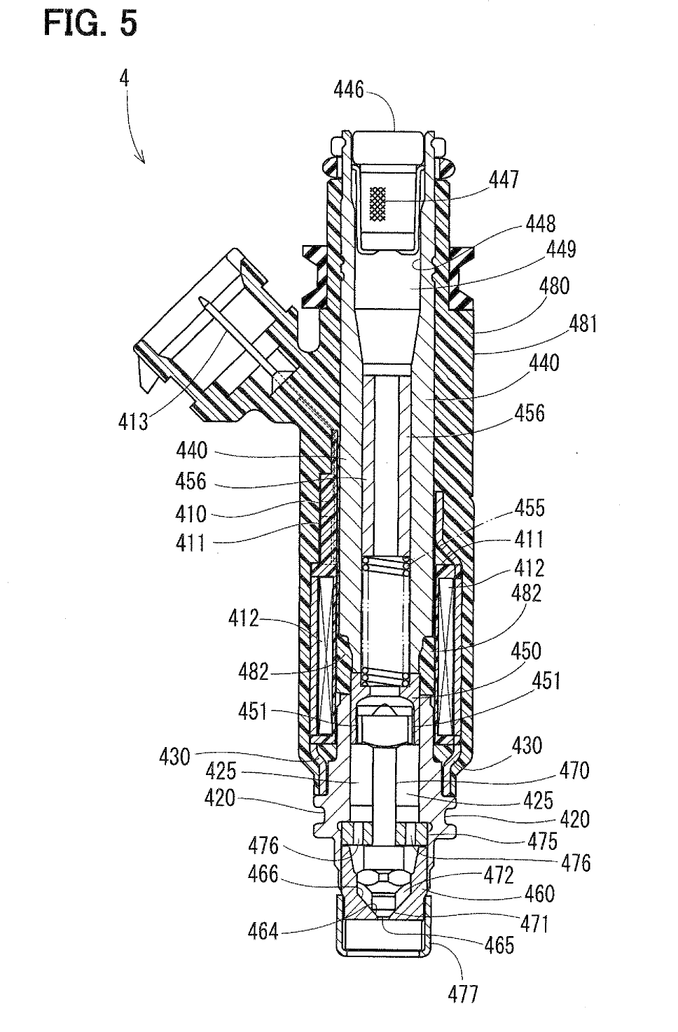

An injector using an electromagnetic valve according to a third embodiment of the invention is illustrated in FIG. 5. An injector 4 as a fluid injection system is used, for example, as a fuel injection system which injects fuel into an inlet port of a gasoline engine. The injector 4 includes a driving force generating part 410, a connector 420, a housing 430, a stator 440, a movable part 450, a coil spring 455 as an urging member, a valve body 460 as a valve body, a needle 470 as a valve member, and a resin formed member 480.

The driving force generating part 410 includes a bobbin 411, a coil 412, and a terminal 413. The bobbin 411 is disposed radially outward of the connector 420 and the stator 440. The coil 412 is wound around the bobbin 411. The terminal 413 is electrically connected to the coil 412, and electric power from an external power is supplied to the coil 412 via the terminal 413.

The connector 420 is cylindrically formed from a magnetic material such as magnetic stainless steel, and accommodates the movable part 450 and the needle 470 so as to allow their reciprocation movements. The connector 420 defines a fuel passage 425 therein. The fuel passage 425 communicates with a fuel hole 476 in a spacer 475. The housing 430 covers an outer circumference of the coil 412. The housing 430 magnetically connects the connector 420 and the stator 440.

The stator 440 and the movable part 450 are made of magnetic materials such as magnetic stainless steel, and constitute a magnetic circuit together with the connector 420 and the housing 430. The stator 440 is cylindrically formed, and is disposed radially inward of the coil 412. A fuel inlet 446 is formed at an end portion of the stator 440 on the opposite side from the connector 420. Fuel is supplied to the fuel inlet 446 from a fuel pump (not shown). The fuel supplied to the fuel inlet 446 flows into a fuel passage 449 as a second fluid passage defined by an inner circumferential surface 448 of the stator 440 through a fuel filter 447. The fuel passage 449 communicates with a clearance 451 defined between the movable part 450 and the needle 470. The fuel filter 447 removes foreign substances contained in fuel.

The movable part 450 is cylindrically formed, and is disposed radially inward of the connector 420 to be reciprocated in the axial direction. An end portion of the movable part 450 on the opposite side from the stator 440 is connected integrally to 470. The movable part 450 is in contact with the coil spring 455 at its end portion on the stator 440 side. One end portion of the coil spring 455 is in contact with the movable part 450, and the other end portion of the coil spring 455 is in contact with an adjusting pipe 456. The adjusting pipe 456 is press-fitted into the stator 440. By adjusting a press-fitted amount of the adjusting pipe 456, a load of the coil spring 455 urging the movable part 450 is changed.

The valve body 460 is provided at an end portion of the connector 420 on the opposite side from the stator 440. The valve body 460 is cylindrically formed, and includes a nozzle hole 465 at its end portion on the opposite side from the fuel inlet 446 in the axial direction. The valve body 460 has an inner wall 466 having a conical shape, and an inner diameter of the inner wall 466 becomes smaller toward the nozzle hole 465 at a front end of the valve body 460. The valve body 460 has a valve seat 464 on the inner wall 466 in a conical shape. A sleeve 477 is provided on an outer circumference of the valve body 460 on the nozzle hole 465 side.

The needle 470 as a valve member is accommodated radially inward of the connector 420 and the valve body 460 so as to be reciprocated in the axial direction. The needle 470 has a seat part 471 at its end portion on the opposite side from the fuel inlet 446. The seat part 471 engages and disengages from the valve seat 464 of the valve body 460. The needle 470 and the valve body 460 define a fuel pocket chamber 472, through which fuel flows, therebetween. The clearance 451 defined between the movable part 450 and the needles 470, the fuel passage 425, the fuel hole 476 of the spacer 475, and the fuel pocket chamber 472 constitute the “first fluid passage”.

The resin formed member 480 includes an accommodating member 481 and a nonmagnetic member 482. The accommodating member 481 covers the driving force generating part 410, the connector 420, the housing 430 and the stator 440. The nonmagnetic member 482 is located radially inward of the coil 412 as well as between the connector 420 and the stator 440, and is formed from resin integrally with the accommodating member 481. The nonmagnetic member 482 prevents a short circuit of magnetic flux between the connector 420 and the stator 440. A method of forming the resin formed member 480 is described hereinafter.

Next, workings of the injector 4 are explained. When energization of the coil 412 is stopped, magnetic attraction force is not generated between the stator 440 and the movable part 450. Accordingly, the movable part 450 is displaced together with the needle 470 in the opposite direction of the stator 440 by urging force of the coil spring 455. As a result, when the energization of the coil 412 is stopped, the seat part 471 of the needle 470 engages the valve seat 464. Therefore, fuel is not injected through the nozzle hole 465.

Upon energization of the coil 412, a magnetic circuit is formed in the housing 430, the connector 420, the movable part 450 and the stator 440 by a magnetic field generated in the coil 412. Meanwhile, the nonmagnetic member 482 prevents the short circuit of magnetic flux between the connector 420 and the stator 440. Accordingly, magnetic attraction force is generated between the stator 440 and the movable part 450. When the magnetic attraction force generated between the stator 440 and the movable part 450 becomes larger than the urging force of the coil spring 455, the movable part 450 and the needle 470 are displaced integrally toward the stator 440 side. As a result, the seat part 471 of the needle 470 disengages from the valve seat 464.

Fuel, which has flowed into the injector 4 through the fuel inlet 446, flows into the fuel pocket chamber 472 via the fuel filter 447, the fuel passage 449, the clearance 451 defined between the movable part 450 and the needle 470, the fuel passage 425, and the fuel hole 476 in the spacer 475 in this order. The fuel in the fuel pocket chamber 472 flows into the nozzle hole 465 through between the valve seat 464 and the seat parts 471. As a result, fuel is injected through the nozzle hole 465.

When the energization of the coil 412 is stopped, the magnetic attraction force between the stator 440 and the movable part 450 no longer exists. Accordingly, the movable part 450 and the needle 470 are displaced integrally toward the opposite side from the stator 440 by the urging force of the coil spring 455. As a result, the seat part 471 engages the valve seat 464 again so as to block a flow of fuel between the fuel pocket chamber 472 and the nozzle hole 465. Thus, the injection of fuel through the nozzle hole 465 is ended.

The method of forming the nonmagnetic member in the third embodiment is described below. In the third embodiment, the driving force generating part 410, the connector 420, the stator 440 are appropriately arranged, and the connector 420 and the stator 440, and the housing 430 are welded together. Then, the resin formed member 480 is insert-molded using a metal mold (not shown). A joining portion between the resin and metal is integrally processed liquid-tightly by, for example, an NMT (nano molding technology) method. Consequently, a metal resin complex, in which the driving force generating part 410, the connector 420, the housing 430, the stator 440, and the resin formed member 480 are integrally formed, is formed. Meanwhile, a region defined among the bobbin 411, the connector 420 and the stator 440 is the nonmagnetic member 482, and has a function of preventing the short circuit of magnetic flux between the connector 420 and the stator 440.

As has been described in detail thus far, according to the injector 4 in the third embodiment, by performing the insert molding after positioning the driving force generating part 410, the stator 440, and the connector 420 at their appropriate positions, the working process is simplified. The laser welding between the connector 420 and the stator 440, and the nonmagnetic member 482 becomes unnecessary. The third embodiment is characterized in that the nonmagnetic member 482 is formed integrally with the accommodating member 481 which accommodates the driving force generating part 410. If positions of the driving force generating part 410, the stator 440, and the connector 420 are appropriately determined using a configuration of the third embodiment, the attraction is stabilized without precise formation of thickness and length of the nonmagnetic member 482 as in the conventional technology. The resin formed member 480 is formed integrally with the driving force generating part 410, the stator 440 and the connector 420, so that the joint strength improves and rigidity is high. As a result, their deformations in attaching the engine or pump is prevented. Also, because a material having good magnetic properties is selected for the magnetic member, a magnetic circuit having good magnetic properties is configured.

### Fourth Embodiment

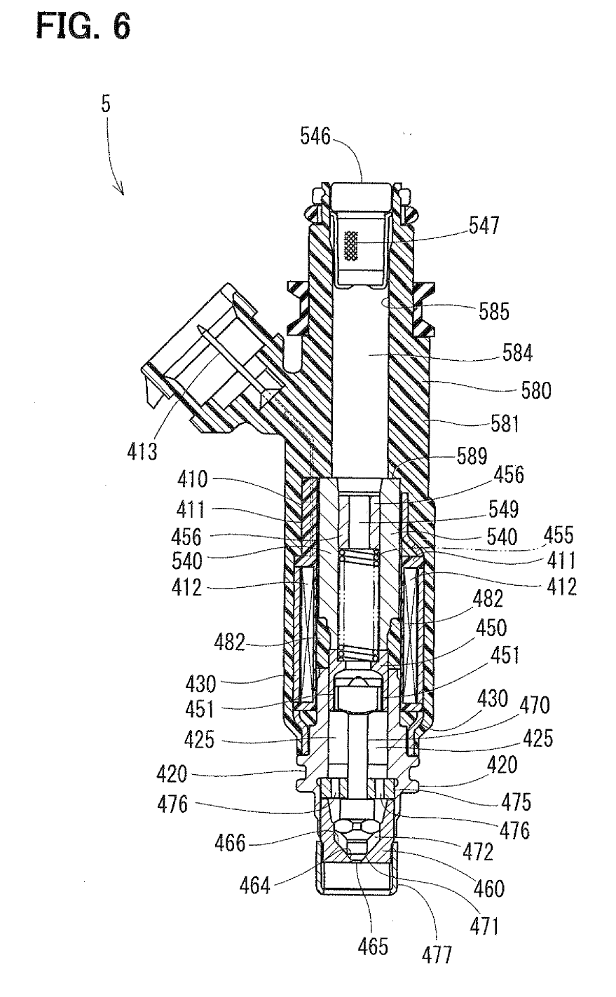

An injector according to a fourth embodiment of the invention is illustrated in FIG. 6. The same numeral is used for indicating substantially the same component as the third embodiment. In the injector 5 of the fourth embodiment, similar to the third embodiment, a resin formed member 580 is insert-molded from resin integrally with a driving force generating part 410, a connector 420, a housing 430 and a stator 540. A joining portion between the resin and metal is integrally processed liquid-tightly by, for example, an NMT method.

A fuel inlet 546 is formed at an end portion of the cylindrically-formed resin formed member 580 on the opposite side from the connector 420. Fuel from a fuel pump (not shown) is supplied to the fuel inlet 546. The fuel supplied to the fuel inlet 546 flows into a fuel passage 584 as a third fluid passage defined by an inner circumferential surface 585 of the resin formed member 580 through a fuel filter 547. The fuel filter 547 removes foreign substances contained in fuel.

The stator 540 is shortened to a necessary length for the formation of a magnetic circuit. A fuel passage 549 as the second fluid passage formed inside the stator 540 communicates with the fuel passage 584. An end portion 589 of the stator 540 on the fuel inlet 546 side and the resin formed member 580 are integrally formed liquid-tightly by an NMT method.

As a result, similar effects to the third embodiment are produced, and moreover, by shortening the stator 540, weight of the injector 5 is reduced.

The resin formed member 580 has the third fluid passage which communicates with the second fluid passage. Therefore, a part of the fluid passage is defined by the resin formed member 580, and thereby the stator 540 is shortened to a necessary length for a magnetic circuit. Accordingly, the stator 540 made of metal such as stainless steel becomes short, so that weight of the injector 5 is reduced.

### Fifth Embodiment

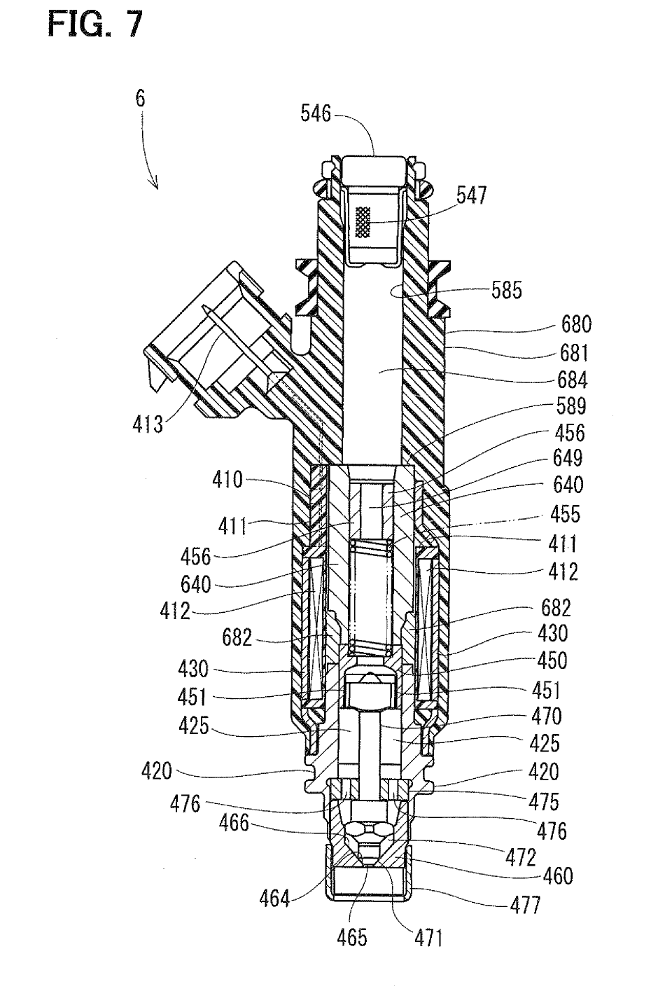

An injector according to a fifth embodiment of the invention is illustrated in FIG. 7. The same numeral is used for indicating substantially the same component as the fourth embodiment.

In the injector 6 of the fifth embodiment, a nonmagnetic member 682 is formed from metal which is a nonmagnetic material A resin formed member 680 has an accommodating member 681. A fuel passage 684 as the third fluid passage is defined radially inward of the resin formed member 680. A stator 640 is shortened to a necessary length for the formation of a magnetic circuit. A fuel passage 649 as the second fluid passage formed inside the stator 640 communicates with the fuel passage 684. An end portion 589 of the stator 640 on a fuel inlet side and the resin formed member 680 are integrally formed liquid-tightly by an NMT method. Since the stator 640 is shortened, similar to the fourth embodiment, weight of the injector 6 is reduced.

The resin formed member 680 defines a part of the fluid passage, and thereby the stator 640 is shortened to a necessary length for a magnetic circuit. Thus, the stator 640 formed from metal, such as stainless steel, becomes short, so that weight of the injector 6 is reduced.

### Other Embodiments

In the above embodiments, the electromagnetic valve is applied to a fuel regulating valve of a high pressure supply pump for a gasoline cylinder direct-injection engine, and a fuel injection system which injects fuel into an inlet port of a gasoline engine. Alternatively, the electromagnetic valve may be applied to a high pressure pump of a diesel engine, other pumps, various injectors, other electromagnetic valves, or the like. In the above embodiments, the NMT method is used as a method of bonding metal and resin together. Alternatively, in another embodiment, any method may be employed as long as metal and resin are bonded together so that fuel leak, for example, is not caused. PPS (poly phenylene sulfide), PBT (poly buthylene terephthalate), nylon (registered trademark), and the like may be used for the resin.

The invention is not by any means limited to the above embodiments, and may be embodied in various modes without departing from the scope of the invention.

Additional advantages and modifications will readily occur to those skilled in the art. The invention in its broader terms is therefore not limited to the specific details, representative apparatus, and illustrative examples shown and described.

What is claimed is:

1. An electromagnetic valve comprising:
a valve body having a first fluid passage and a valve seat;
a valve member configured to engage or disengage from the valve seat so as to stop or allow a flow of fluid through the first fluid passage respectively;
an urging member configured to urge the valve member in a direction in which the flow of fluid is stopped or allowed;
a movable part configured to reciprocate in an axial direction thereof together with the valve member;
a connector made of a magnetic material and accommodating the movable part so as to allow reciprocating movement of the movable part;
a stator made of a magnetic material and constituting a magnetic circuit together with the movable part and the connector so as to attract the movable part;
a coil configured to generate magnetic force upon energization of the coil, wherein the magnetic force attracts the movable part to the stator;
a terminal electrically connected to the coil for supplying a drive current to the coil so as to energize the coil; and
a resin-formed member including:
an accommodating member in which the coil and the terminal are embedded; and
a nonmagnetic member made of a nonmagnetic material and located radially inward of the coil as well as between the connector and the stator for preventing a magnetic short circuit between the connector and the stator, wherein the accommodating member and the nonmagnetic member are formed integrally from resin.

2. The electromagnetic valve according to claim 1, wherein the resin-formed member is formed integrally with at least one of the connector and the stator as a metal-resin complex.

3. The electromagnetic valve according to claim 2, wherein the resin-formed member is liquid-tightly formed integrally with at least one of the connector and the stator as a continuous element.

4. The electromagnetic valve according to claim 1, wherein the coil is an air core coil.

5. A fluid pump comprising:
an electromagnetic valve including:
a valve body having a first fluid passage and a valve seat;
a valve member configured to engage or disengage from the valve seat so as to stop or allow a flow of fluid through the first fluid passage respectively;
an urging member configured to urge the valve member in a direction in which the flow of fluid is allowed;
a movable part configured to reciprocate in an axial direction thereof together with the valve member;
a connector made of a magnetic material and accommodating the movable part so as to allow reciprocating movement of the movable part;
a stator made of a magnetic material and constituting a magnetic circuit together with the movable part and the connector so as to attract the movable part;
a coil configured to generate magnetic force upon energization of the coil, wherein the magnetic force attracts the movable part to the stator;
a terminal electrically connected to the coil for supplying a drive current to the coil so as to energize the coil; and
a resin-formed member having:
an accommodating member in which the coil and the terminal are embedded; and
a nonmagnetic member made of a nonmagnetic material and located radially inward of the coil as well as between the connector and the stator for preventing a magnetic short circuit between the connector and the stator, wherein the accommodating member and the nonmagnetic member are formed integrally from resin; and
a pump part including:
a piston configured to pressurize fluid which flows from the electromagnetic valve; and
a cylinder body accommodating the piston so as to allow sliding reciprocation of the piston.

6. The fluid pump according to claim 5 wherein the resin-formed member is formed integrally with at least one of the connector and the stator as a metal-resin complex.

7. The fluid pump according to claim 6, wherein the resin-formed member is liquid-tightly formed integrally with at least one of the connector and the stator as a continuous element.

8. The fluid pump according to claim 5, wherein the coil is an air core coil.

9. A fluid injection system comprising:
an electromagnetic valve including:
a valve body having a first fluid passage, a valve seat, and a nozzle hole communicating with the first fluid passage;
a valve member configured to engage or disengage from the valve seat so as to stop or allow a flow of fluid through the first fluid passage respectively;
an urging member configured to urge the valve member in a direction in which the flow of fluid is stopped;
a movable part configured to reciprocate in an axial direction thereof together with the valve member;
a connector made of a magnetic material and accommodating the movable part so as to allow reciprocating movement of the movable part;
a stator made of a magnetic material and constituting a magnetic circuit together with the movable part and the connector so as to attract the movable part;
a coil configured to generate magnetic force upon energization of the coil, wherein the magnetic force attracts the movable part to the stator;
a terminal electrically connected to the coil for supplying a drive current to the coil so as to energize the coil; and
a resin-formed member having:
an accommodating member in which the coil and the terminal are embedded; and
a nonmagnetic member made of a nonmagnetic material and located radially inward of the coil as well as between the connector and the stator for preventing a magnetic short circuit between the connector and the stator, wherein:
the accommodating member and the nonmagnetic member are formed integrally from resin; and
the stator has a cylindrical shape and includes a second fluid passage communicating with the first fluid passage inside the stator.

10. The fluid injection system according to claim 9, wherein the resin-formed member includes a third fluid passage communicating with the second fluid passage.

11. The fluid injection system according to claim 9, wherein the resin-formed member is formed integrally with at least one of the connector and the stator as a metal-resin complex.

12. The fluid injection system according to claim 11, wherein the resin-formed member is liquid-tightly formed integrally with at least one of the connector and the stator as a continuous element.

13. The fluid injection system according to claim 9, wherein the coil is an air core coil.

14. A fluid injection system comprising:
an electromagnetic valve including:
a valve body having a first fluid passage, a valve seat, and a nozzle hole communicating with the first fluid passage;
a valve member configured to engage or disengage from the valve seat so as to stop or allow a flow of fluid through the first fluid passage respectively;
an urging member configured to urge the valve member in a direction in which the flow of fluid is stopped;
a movable part configured to reciprocate in an axial direction thereof together with the valve member;
a connector made of a magnetic material and accommodating the movable part so as to allow reciprocating movement of the movable part;
a stator made of a magnetic material and constituting a magnetic circuit together with the movable part and the connector so as to attract the movable part;
a coil configured to generate magnetic force upon energization of the coil, wherein the magnetic force attracts the movable part to the stator;
a terminal electrically connected to the coil for supplying a drive current to the coil so as to energize the coil;
a resin-formed member having an accommodating member in which the coil and the terminal are embedded; and
a nonmagnetic member made of a nonmagnetic material and located radially inward of the coil as well as between the connector and the stator for preventing a magnetic short circuit between the connector and the stator, wherein:
the stator has a cylindrical shape and includes a second fluid passage communicating with the first fluid passage inside the stator; and
the resin-formed member includes a third fluid passage communicating with the second fluid passage.

15. The fluid injection system according to claim 14, wherein the resin-formed member is formed integrally with at least one of the connector and the stator as a metal-resin complex.

16. The fluid injection system according to claim 15, wherein the resin-formed member is liquid-tightly formed integrally with at least one of the connector and the stator as a continuous element.

17. The fluid injection system according to claim 14, wherein the coil is an air core coil.
